(19) United States
(12) Patent Application Publication
(10) Pub. No.: US 2023/0277991 A1
(43) Pub. Date: Sep. 7, 2023

(54) A Mixing Apparatus and Mixing Method

(71) Applicant: Saint-Gobain Placo, Courbevoie (FR)

(72) Inventors: Hamouda Jaffel, Courbevoie (FR); Sophie Quelen, Courbevoie (FR); Jean-Luc Marin, Courbevoie (FR)

(21) Appl. No.: 18/007,443

(22) PCT Filed: Jul. 14, 2021
(86) PCT No.: PCT/EP2021/069671

§ 371 Date: Jan. 30, 2023

(30) Foreign Application Priority Data
Jul. 31, 2020 (EP) 20305887.0

(51) Int. Cl. B01F 27/1152; B01F 27/90; B01F 27/92; B01F 35/71

(52) U.S. Cl. CPC B01F 27/1152; B01F 27/90; B01F 27/923; B01F 35/711

(57) ABSTRACT

Lightweight construction panels, such as plasterboard, (e.g. gypsum plasterboard) are commonly used to provide internal partitions in buildings. Sheets of plasterboard are typically carried and positioned by hand. Accordingly, it is desirable to reduce the weight of plasterboard. It is known to include an aqueous foam in the stucco slurry used to produce plasterboards. However, prior known mixers have been found to destroy foam bubbles. The present invention provides a stucco slurry mixing apparatus (100) including an inlet (130) for the introduction of foam into a mixing chamber (110), wherein the inlet (130) includes an inlet aperture (132) in a wall of the mixing chamber (110) and an inlet conduit (134) extending therefrom such that a relative angle between a longitudinal axis (136) of the inlet conduit (134) and a tangent (140) to a mixing path (124) defined by a mixing member (120) is less than 90 degrees.

### FIELD OF THE INVENTION

The present invention relates to a slurry mixing apparatus, and in particular, to a stucco slurry mixing apparatus providing a more desirable stucco slurry.

### BACKGROUND OF THE INVENTION

Lightweight construction panels, such as plasterboard, (e.g. gypsum plasterboard) are commonly used to provide internal partitions in buildings. To provide a partition, it is typical to first construct a framework from wood, metal, or another suitable material, and affix sheets of plasterboard to the frame with screws or other fixings to provide a continuous partition surface. It is also known to affix said panels to solid walls, such as brick walls, to provide a more desirable finished surface. Said panels are typically used to construct walls and ceilings. Plasterboard is typically formed from a stucco slurry. Stucco and other additives are typically combined with water to form the slurry, which is then dried at elevated temperatures to form plasterboard.

Sheets of plasterboard are typically carried and positioned by hand. Accordingly, it is desirable to reduce the weight of plasterboard. Furthermore, lighter weight boards require less substantial supporting framework, which increases ease of installation and reduces cost. It is known to include an aqueous foam in the slurry used to form the plasterboard sheets. The foam contains air bubbles which, once the plasterboard sheets have been formed, result in micro voids in the finished plasterboard sheet thereby reducing its weight.

The mixing action of prior known mixing apparatus has been found to destroy foam bubbles. Furthermore, many known ingredients used in the manufacture of plasterboard are hydrophobic and these ingredients may destroy the foam bubbles on contact. In an attempt to overcome these problems, it is known to provide a greater amount of foam. However, this results in an undesirably high level of foaming agent or surfactant in the slurry.

It is also known to mix the slurry to a lesser extent in an attempt to reduce the destruction of the bubbles. However, this has been found to result in a non-homogeneous stucco slurry, which in turn results in plasterboard which does not have continuous properties.

Objects and aspects of the present invention seek to alleviate at least these problems with prior known mixing apparatus.

### SUMMARY OF THE INVENTION

According to a first aspect of the present invention, there is provided a stucco slurry mixing apparatus comprising:
a vessel for receiving and mixing ingredients therein;
a mixing member configured to move within the vessel and mix ingredients contained therein, wherein the movement of the mixing member defines a non-rectilinear mixing path;
wherein the vessel comprises:
a first inlet for the introduction of ingredients comprising at least aqueous foam into the vessel, wherein the first inlet comprises an inlet aperture in a wall of the vessel and an inlet conduit extending therefrom such that a relative angle between a longitudinal axis of the inlet conduit and a tangent to the mixing path is less than 90 degrees,
a second inlet comprising a second inlet aperture in a wall of the vessel for the introduction of further ingredients into the vessel; and
an outlet for mixed slurry,
wherein the first inlet and outlet are positioned such that, in use, the average residence time of the aqueous foam within the vessel is similar to the average residence time of the other components of the stucco slurry within the vessel.

In this way, a stucco slurry mixing apparatus that assists in ensuring materials entering the apparatus via the first inlet are dispersed within a well homogenised stucco slurry is provided. As aqueous foam is provided via the first inlet, this may reduce the destruction of bubbles within the foam, thereby reducing the required volume of foaming agent or surfactant to achieve a desired aeration level in the final plasterboard product. The foam efficiency may therefore be maximised. Furthermore, foaming agent or surfactant level is minimised.

The inlet conduit may extend from the inlet aperture in a direction away from a direction of rotation of the mixing member. In this way, foam travelling along the inlet conduit may have a movement direction and that is at least partially matched to the movement direction of stucco slurry being mixed in the vessel adjacent to the first inlet. The inlet aperture may be an opening in the wall of the vessel. The inlet conduit may comprise a pipe, a tube, and or any other structure suitable for the conveyance of an aqueous foam therethrough. The inlet conduit may be linear. The inlet conduit may be rectilinear. Alternatively, the inlet conduit may be curved. The inlet conduit may comprise a rectilinear portion immediately adjacent to the inlet aperture, and a curved portion extending from the rectilinear portion. In this way, the overall volume and/or footprint of the mixing apparatus may be reduced, whilst still providing a rectilinear inlet conduit portion adjacent to the inlet aperture.

In some embodiments of the invention, an aqueous foam may be provided via the first inlet with a velocity that is matched to the velocity of the stucco slurry being mixed in the vessel adjacent to the first inlet, thereby reducing shear forces on the foam. Furthermore, the foam may be near instantaneously dispersed within a well homogenised stucco slurry being mixed within the vessel, which allows for the required mixing time to be reduced. Accordingly, the present invention may provide a more desirable stucco slurry.

The mixing path may lie entirely within a single plane. Accordingly, the mixing member may have only a single direction of movement, such as rotation about a single axis. The longitudinal axis of the inlet conduit may lie parallel to and spaced from the plane in which the mixing path lies. In this way, ingredients, such as foam, introduced via the first inlet may not be directed immediately towards the mixing member. Such an arrangement may prevent foam being impacted and destroyed by the mixing member before it has been incorporated into the stucco slurry.

The mixing member may be positioned between the first inlet and the outlet. In this way, ingredients, such as foam, introduced via the first inlet may be required to pass through and/or beyond the mixing member before being removed from the vessel via the outlet. In this way, the stucco slurry may be homogenised. Alternatively, the first inlet may be positioned between the mixing member and the outlet. In this way, the aqueous foam introduced into the vessel via the first outlet will not come into direct contact with the mixing member.

The mixing member may be positioned between the second inlet and the outlet. In this way, the further ingredients introduced via the second inlet may be required to pass through or beyond the mixing member before being removed from the vessel via the outlet. Accordingly, the stucco slurry may be homogenised. Alternatively, the second inlet may be positioned between the mixing member and the outlet.

Preferably, the inlet aperture is in a side wall of the vessel. The side wall or side walls of the vessel is the dimension of the vessel which is substantially perpendicular to a plane in which the mixing member moves during mixing. In embodiments where the vessel is cylindrical and the mixing member is a rotating disk, the side wall is substantially perpendicular to the plane in which the rotating disk rotates. Therefore, in such embodiments the side wall is substantially parallel to the axis of rotation of the rotating disk. Furthermore, in use, the side wall or walls of the vessel are often substantially perpendicular to the ground.

Preferably, the second inlet aperture is in a top wall of the vessel. The top wall of the vessel is the boundary of the vessel that, in use, is substantially parallel to a plane in which the mixing member moves during mixing. The top wall may also be considered the, in use, highest boundary of the vessel.

Preferably, the second inlet may be spaced from the first inlet. In this context, the term spaced should be interpreted to mean that the first inlet and the second inlet are sufficiently far removed from one another such that the ingredients they provide are substantially incorporated into the slurry before they interact with one another. Preferably, the first inlet and second inlet are spaced from one another vertically within the vessel. Preferably, the first inlet and second inlet are spaced from one another horizontally within the vessel. Preferably, the first inlet and second inlet are spaced from one another around the circumference of the vessel. More preferably, the first inlet and second inlet are spaced from one another around in more than one dimension, for example, but not limited to, vertically and around the circumference of the vessel.

In this way, the aqueous foam introduced via the first inlet may be kept separate from the further ingredients introduced via the second inlet in the initial phase of mixing. Such a feature may be especially advantageous where hydrophobic additives are introduced to the vessel via the second inlet, as separating the aqueous foam from the hydrophobic additives in the initial phase of mixing is considered to increase foam efficiency.

The present invention may prove beneficial when mixing stucco slurry for use in the manufacture of moisture resistant plasterboard. Slurries for the manufacture of moisture resistant plasterboards include hydrophobising additives that have the effect of destabilising aqueous foams. This destabilising effect is particularly apparent when the hydrophobising additive comprises, or is based on, a siloxane oil (for example polymethyl hydro siloxane).

The present invention may also prove beneficial when mixing stucco slurries including a high level of recycled plaster materials, as these recycled materials may include a significant proportion of hydrophobic materials. Without adequate management such as that provided in the present invention, this hydrophobic material can significantly destabilise the aqueous foam during mixing, potentially resulting in production losses (loss of foam volume during mixing). Additionally, given the continued and increasing drive to recycle materials, the portion of recycled material in future plasterboards will likely increase in the future, making this issue of increased significance. The hydrophobic gypsum particles introduced to a slurry could come from recycled moisture resistant products as well as recovered sawing and trimming dusts.

In cases where a moisture resistant plasterboard is manufactured using recycled material, the above effects may occur in combination to provide an extremely strong destabilisation effect on the aqueous foam unless managed correctly as with the present invention.

The first inlet may be provided adjacent to a periphery of the vessel and the second inlet may be provided adjacent to a centre of the vessel. In this way, ingredients, such as foam, introduced via the first inlet may be kept away from ingredients, such as hydrophobic additives, introduced via the second inlet for longer than an arrangement in which each of the inlets are positioned adjacent to each other.

Preferably, the first inlet and outlet are spaced from one another. In this context, the term spaced should be interpreted to mean that the first inlet and outlet are sufficiently far removed from one another such that the aqueous foam is mixed throughout the stucco slurry such that the stucco slurry is generally homogenous. Preferably, the first inlet and outlet are spaced from one another vertically within the vessel. Preferably, the first inlet and outlet are spaced from one another horizontally within the vessel. Preferably, the first inlet and outlet are spaced from one another around the circumference of the vessel. More preferably, the first inlet and outlet are spaced from one another around in more than one dimension, for example, but not limited to, vertically and around the circumference of the vessel.

Preferably, the first inlet and the outlet are positioned such that, in use, the aqueous foam progresses from the first inlet to the outlet along a substantially spiral pathway.

The inlet aperture may be elliptical or oval in shape. Alternatively, the inlet aperture may be slot shaped, such as a curved or C-shaped slot. In this way, the back pressure experienced at the inlet aperture may be reduced, when compared to other shapes such as circular.

The tangent may be the tangent to the mixing path at a point adjacent to the inlet aperture.

The inlet conduit may extend from the inlet aperture such that a relative angle between the longitudinal axis of the inlet conduit and the tangent to the mixing path is between 89 and 0 degrees. Alternatively, the inlet conduit may extend from the inlet aperture such that a relative angle between the longitudinal axis of the inlet conduit and the tangent to the mixing path is between 70 and 0 degrees. Alternatively, the inlet conduit may extend from the inlet aperture such that a relative angle between the longitudinal axis of the inlet conduit and the tangent to the mixing path is between 45 and 0 degrees. Alternatively, the inlet conduit may extend from the inlet aperture such that a relative angle between the longitudinal axis of the inlet conduit and the tangent to the mixing path is between 30 and 0 degrees. Alternatively, the inlet conduit may extend from the inlet aperture such that a relative angle between the longitudinal axis of the inlet conduit and the tangent to the mixing path is between 20 and 0 degrees.

The inlet conduit may extend from the inlet aperture such that a relative angle between the longitudinal axis of the inlet conduit and the tangent to the mixing path is less than 89 degrees. Alternatively, the inlet conduit may extend from the inlet aperture such that a relative angle between the longitudinal axis of the inlet conduit and the tangent to the mixing path is less than 70 degrees. Alternatively, the inlet conduit may extend from the inlet aperture such that a relative angle between the longitudinal axis of the inlet conduit and the tangent to the mixing path is less than 45 degrees. Alternatively, the inlet conduit may extend from the inlet aperture such that a relative angle between the longitudinal axis of the inlet conduit and the tangent to the mixing path is less than 30 degrees. Alternatively, the inlet conduit may extend from the inlet aperture such that a relative angle between the longitudinal axis of the inlet conduit and the tangent to the mixing path is less than 20 degrees.

The inlet conduit may extend from the inlet aperture such that the longitudinal axis of the inlet conduit is parallel to the tangent to the mixing path. In this way, the movement direction and/or velocity of foam introduced via the first inlet may be more closely matched to the movement direction and/or velocity of the stucco slurry being mixed in the vessel adjacent to the first inlet, thereby reducing shear forces on the foam.

The vessel may further comprise a third inlet. Preferably, the third inlet includes a third inlet aperture in a wall of the vessel and a third inlet conduit extending therefrom such that a relative angle between a longitudinal axis of the third inlet conduit and a tangent to the mixing path is less than 90 degrees. Any feature hereinbefore described in relation to the first inlet may also apply to the third inlet. Preferably, the third inlet may be spaced from the first inlet. Furthermore, a plurality of inlets may allow for foam to be introduced at a plurality of locations, thereby improving the homogeneousness of the slurry. In addition, a plurality of inlets may allow for the back pressure experienced at each inlet to be reduced. Accordingly, the resulting individual shear level at each inlet may be reduced. Preferably, the mixing member is positioned between the third inlet and the outlet. Alternatively, the third inlet is positioned between the mixing member and the outlet.

The outlet comprises an outlet aperture. The outlet may further comprise an outlet conduit. Preferably, the outlet conduit diverges from a direction of rotation of the mixing member as it extends away from the outlet aperture. In this way, the path of the outlet conduit can be aligned with the direction of movement of the stucco slurry being mixed in the vessel adjacent to the outlet aperture. Accordingly, the slurry may not be compressed and/or otherwise affected to such an extent that bubbles in the slurry are destroyed as the slurry is removed from the vessel. The outlet aperture may be an opening in the wall of the vessel. The outlet conduit may comprise a pipe, a tube, and or any other structure suitable for the conveyance of a slurry therethrough. The outlet conduit may be linear. The outlet conduit may be rectilinear. Alternatively, the outlet conduit may be curved. The outlet conduit may comprise a rectilinear portion immediately adjacent to the outlet aperture, and a curved portion extending from the rectilinear portion. In this way, the overall volume of the mixing apparatus may be reduced, whilst still providing a rectilinear outlet conduit portion adjacent to the outlet aperture.

The outlet conduit may extend from the outlet aperture such that a relative angle between the longitudinal axis of the outlet conduit and a further tangent to the mixing path is between 89 and 0 degrees. The further tangent may be the tangent to the mixing path at a point adjacent to the outlet aperture. Alternatively, the outlet conduit may extend from the outlet aperture such that a relative angle between the longitudinal axis of the outlet conduit and the further tangent to the mixing path is between 70 and 0 degrees. Alternatively, the outlet conduit may extend from the outlet aperture such that a relative angle between the longitudinal axis of the outlet conduit and the further tangent to the mixing path is between 45 and 0 degrees. Alternatively, the outlet conduit may extend from the outlet aperture such that a relative angle between the longitudinal axis of the outlet conduit and the further tangent to the mixing path is between 30 and 0 degrees. Alternatively, the outlet conduit may extend from the outlet aperture such that a relative angle between the longitudinal axis of the outlet conduit and the further tangent to the mixing path is between 20 and 0 degrees.

The outlet conduit may extend from the outlet aperture such that a relative angle between the longitudinal axis of the outlet conduit and a further tangent to the mixing path is less than 90 degrees. The further tangent may be the tangent to the mixing path at a point adjacent to the outlet aperture. Alternatively, the outlet conduit may extend from the outlet aperture such that a relative angle between the longitudinal axis of the outlet conduit and the further tangent to the mixing path is less than 70 degrees.

Alternatively, the outlet conduit may extend from the outlet aperture such that a relative angle between the longitudinal axis of the outlet conduit and the further tangent to the mixing path is less than 45 degrees. Alternatively, the outlet conduit may extend from the outlet aperture such that a relative angle between the longitudinal axis of the outlet conduit and the further tangent to the mixing path is less than 30 degrees. Alternatively, the outlet conduit may extend from the outlet aperture such that a relative angle between the longitudinal axis of the outlet conduit and the further tangent to the mixing path is less than 20 degrees.

Alternatively, the outlet conduit may extend from the outlet aperture in a manner that is unrelated to the direction and/or orientation of the mixing path. For example, the outlet aperture may be provided at a lowermost point of the vessel, and the outlet conduit may extend downwards therefrom.

The outlet conduit may comprise a further inlet. Accordingly, foam may be introduced via said further inlet directly into the outlet conduit. It is also envisaged that foam may be introduced directly into the outlet. The outlet conduit may comprise a valve and/or a cover. The valve and/or cover may be configured to selectively close the outlet.

Where the slurry mixing apparatus comprises a plurality of outlets, only one, all, or a selection of the outlets may comprise any one or more of the hereinbefore described features alone or in combination.

The outlet allows mixed stucco slurry to be removed from the vessel. The outlet may convey mixed stucco slurry from the vessel to a further piece of equipment configured to produce plasterboard from the stucco slurry. Preferably, the slurry mixing apparatus may comprise a plurality of outlets. Providing a plurality of outlets may decrease the velocity of the mixed stucco slurry exiting the vessel. Accordingly, the mixed stucco slurry, and any foam included therein, may experience a reduced shear level. Accordingly, the amount of foam bubbles destroyed during mixing may be reduced.

It is to be understood that any combination of locations of the inlets relative to the mixing member and the outlet or outlets is envisaged. For example, the first and second inlets may be on a first side of the mixing member and the third inlet and outlet or outlets may be on a second side of the mixing member. In particular, the mixing member may separate the vessel into an upper and a lower section, and the first and second inlets may be provided on the upper section and the third inlet and the outlet or outlets may be provided on the lower section.

The mixing path may be the path along which the stucco slurry being mixed moves around the vessel. The stucco slurry may, during mixing, form a rotating slurry vortex. The mixing path may be the path along which the rotating slurry vortex moves inside the vessel. The mixing path may be defined by the movement of a single element of the mixing member. For example, tracking an end or edge of a mixing member during its movement may provide the mixing path. The mixing path may be round, circular, curved, elliptical, oval, or any other non-rectilinear shape.

Preferably, the first inlet and outlet are positioned such that, in use, the average residence time of the aqueous foam within the vessel is within 30% of the average residence time of the other components of the stucco slurry within the vessel. Still more preferably, in use, the average residence time of the aqueous foam within the vessel is within 20% of the average residence time of the other components of the stucco slurry within the vessel. Yet more preferably, in use, the average residence time of the aqueous foam within the vessel is within 10% of the average residence time of the other components of the stucco slurry within the vessel. Most preferably, in use, the average residence time of the aqueous foam within the vessel is within 5% of the average residence time of the other components of the stucco slurry within the vessel.

The vessel may be a mixing chamber. The vessel may be cylindrical or any other known shape. The vessel may be watertight, save for the inlet and outlet. At least one sensor may be provided to monitor a characteristic of the slurry, such as temperature or density, being mixed inside the vessel. The operation of the mixing apparatus may be automated. Accordingly, the necessary sensors and control equipment may be provided. The inlet aperture may be in a curved wall of the cylindrical vessel. The outlet may also be in the curved wall of the cylindrical vessel. Alternatively, the outlet may be in a planar wall of the cylindrical vessel. In embodiments including a plurality of outlets, outlets may be provided in both the curved wall and the planar wall of the cylindrical vessel.

The mixing member may be a mixing disk. The mixing disk may comprise a plurality of teeth arranged on or along a periphery or curved surface of the disk. The plurality of teeth may be arranged such that the entirety of the periphery or curved surface of the disk is toothed. The mixing disk may comprise a plurality of teeth arranged on at least one substantially planar surface of said disk. The plurality of teeth may be arranged such that the entirety of the at least one planar surface of the disk is toothed.

Alternatively, the mixing member may be a mixing arm. The mixing member may be configured to rotate within the vessel. The mixing member may agitate, stir, fold or otherwise incorporate ingredients within the vessel into a homogenous slurry. The mixing member may be removable from the vessel, for maintenance and/or replacement. The mixing member may be elongate. The mixing member may be helical such that, during movement of the mixing member, stucco slurry is moved by the mixing member from a first area of the vessel to a second area of the vessel.

The mixing member may comprise a plurality of mixing disks and/or arms. Each mixing disk and/or arm may move in a different direction or at a different speed to at least one other mixing disk and/or arm. Each mixing disk and/or arm may be configured to rotate about a common axis. Alternatively, each mixing disk and/or arm may be configured to rotate about a different axis to at least one other mixing disk and/or arm.

The first inlet may comprise a valve and/or a cover. The valve and/or cover may be configured to selectively close the first inlet.

Preferably, the second inlet includes a second inlet conduit extending such that a relative angle between a longitudinal axis of the second inlet conduit and a tangent to the mixing path is less than 90 degrees. Any feature hereinbefore described in relation to the first inlet may also apply to the second inlet.

The apparatus may further comprise a scraper configured to remove ingredients that have become adhered to an interior surface of the vessel. The scraper may comprise at least one rotating member. The scraper may be configured to scrape, in use, an interior surface of an upper wall of the vessel. The scraper may at least partially prevent the build up of ingredients on an interior surface of the vessel. The or each inlet may be positioned between the scraper and the mixing member.

The slurry may be a suspension or a solution. Stucco may be calcium sulphate hemihydrate with the chemical formula CaSO₄½.(H₂O). Accordingly, the slurry may comprise water and stucco. The slurry may further comprise one or more additives, such as fibres, a hydrophobic additive such as silicone oil, recycled materials such as previously produced plasterboard, a phosphate and an acid, amongst others. Some additives, such as hydrophobic additives and recycled materials, may destroy foam on contact. Accordingly, it is desirable to maximise the foam efficiency when producing a stucco slurry including said additives.

Also described in a second aspect of the invention is a method of mixing a stucco slurry using the stucco slurry mixing apparatus of the first aspect of the present invention, the method comprising the steps:
introducing ingredients including at least aqueous foam into the vessel via the first inlet;
introducing further ingredients into the vessel via the second inlet; moving the mixing member to mix the ingredients within the vessel and removing mixed slurry from the vessel via the outlet,
wherein the average residence time of the aqueous foam within the vessel is similar to the average residence time of the other components of the stucco slurry within the vessel.

In this way, there is provided a method that entrains the aqueous foam within the stucco slurry in the vessel.

Preferably, the average residence time of the aqueous foam within the vessel is within 30% of the average residence time of the other components of the stucco slurry within the vessel. Still more preferably, in use, the average residence time of the aqueous foam within the vessel is within 20% of the average residence time of the other components of the stucco slurry within the vessel. Yet more preferably, in use, the average residence time of the aqueous foam within the vessel is within 10% of the average residence time of the other components of the stucco slurry within the vessel. Most preferably, in use, the average residence time of the aqueous foam within the vessel is within 5% of the average residence time of the other components of the stucco slurry within the vessel.

Preferably, the aqueous foam is the only ingredient introduced into the stucco slurry via the first inlet.

Preferably, the further ingredients introduced to the stucco slurry via the second inlet comprise at least one hydrophobic material. The hydrophobic material may comprise solids. The hydrophobic material may comprise liquids.

Preferably, the further ingredients introduced to the stucco slurry via the second inlet comprise solid materials. More preferably, the further ingredients introduced to the stucco slurry via the second inlet consist essentially of solid materials. Most preferably, the further ingredients introduced to the stucco slurry via the second inlet consist of solid materials. It is envisaged that the solid materials may be hydrophobic.

### DETAILED DESCRIPTION

An embodiment of the present invention will now be described by way of example only and with reference to the accompanying drawings, in which:

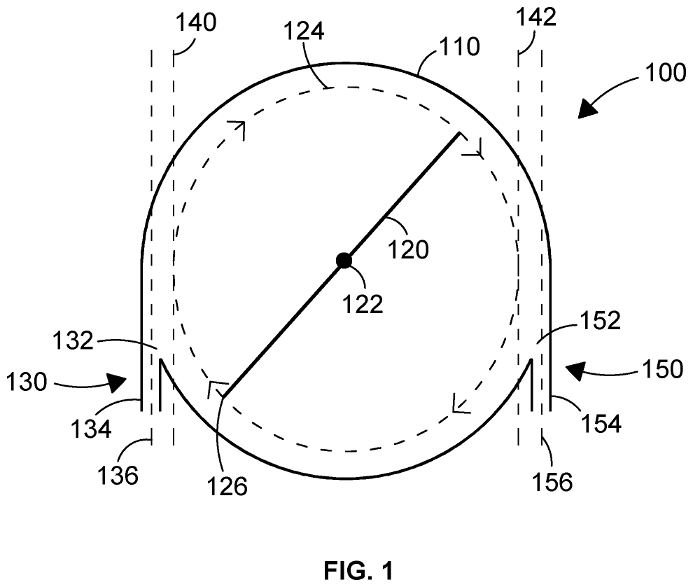

FIG. 1 is a schematic cross-sectional plan view of a first stucco slurry mixer;

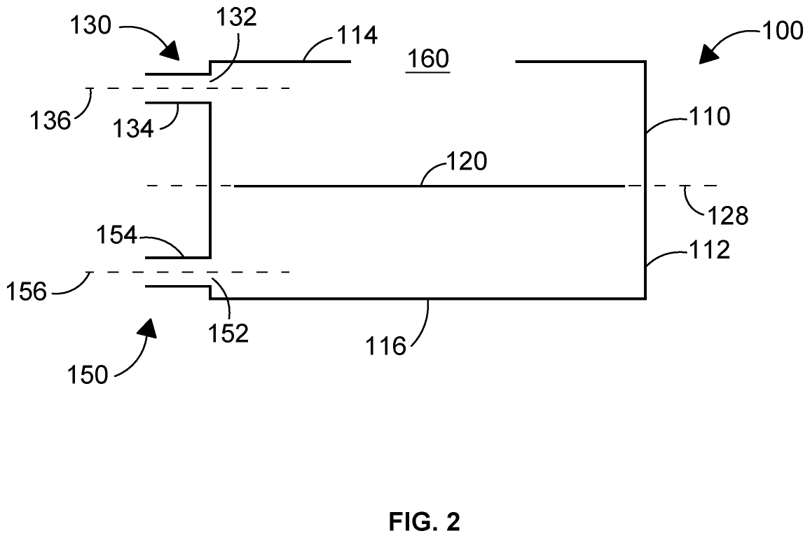

FIG. 2 is a schematic cross-sectional side view of the stucco slurry mixer shown in FIG. 1;

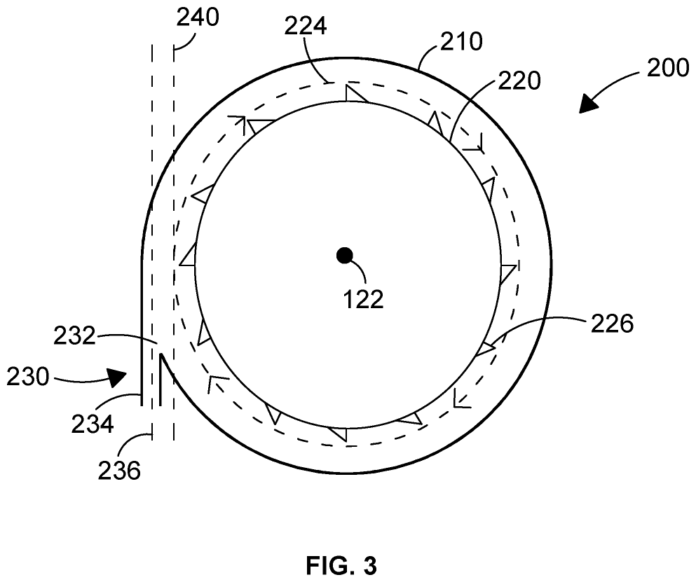

FIG. 3 is a schematic cross-sectional plan view of a second stucco slurry mixer; and

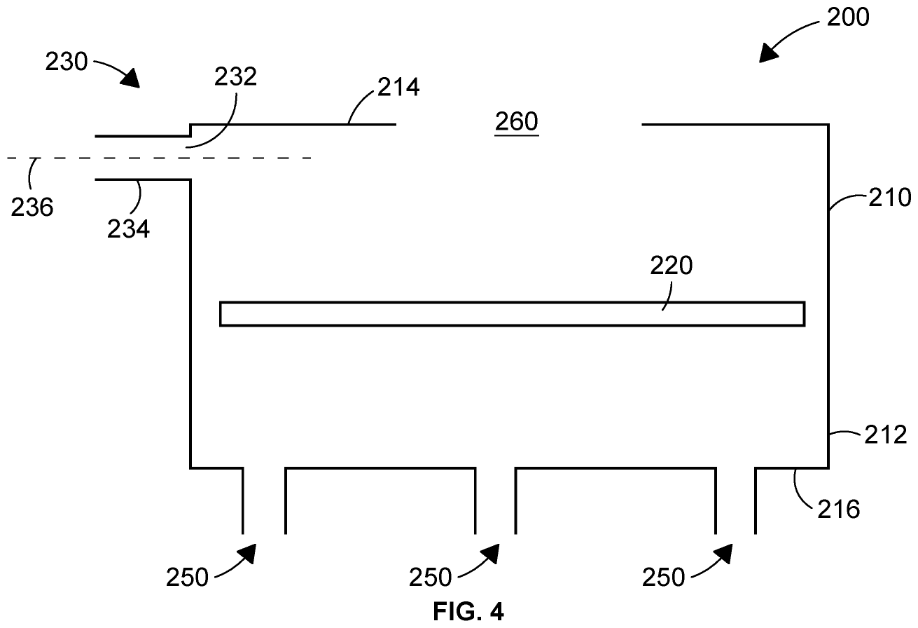

FIG. 4 is a schematic cross-sectional side view of the stucco slurry mixer shown in FIG. 3.

FIG. 1 is a schematic cross-sectional plan view of a first stucco slurry mixer 100. The mixer 100 includes a cylindrical mixing chamber 110. A mixing arm 120 is located within the mixing chamber 110 and is configured to rotate about a central point of rotation 122. The mixing arm 120 is shown to rotate clockwise in the orientation shown in FIG. 1, but anti-clockwise rotation of the mixing arm 120 is also envisaged. Rotation of the mixing arm 120 about the point of rotation 122 defines a circular mixing path 124. The mixing path 124 shown in FIG. 1 is defined by the movement of an end 126 of the mixing arm 120.

The mixer 100 includes a first inlet 130. The mixer 100 also includes a second inlet, which will be described in more detail with reference to FIG. 2 below. The first inlet 130 includes an inlet aperture 132 in a curved wall of the cylindrical mixing chamber 110. The first inlet 130 also includes an inlet conduit 134 which extends from the inlet aperture 132. The inlet conduit 134 extends away from the mixing chamber 110 in a direction opposed to the direction of the mixing path 124. In particular, in the orientation shown in FIG. 1, the mixing path 124 has a generally upward direction at the point adjacent to the first inlet 130, and the inlet conduit 134 extends from the mixing chamber 110 in a generally downward direction.

The inlet conduit 134 of the first inlet 130 extends away from the mixing chamber 110 such that a longitudinal axis 136 of the inlet conduit 134 is parallel to, and spaced from, a first tangent 140 to the circular mixing path 124. The first tangent 140 is a tangent to the mixing path 124 at a point adjacent to the inlet aperture 132. Accordingly, ingredients, such as aqueous foam, may be introduced into the mixing chamber 110 via the first inlet 130 in a direction that is tangential to the direction of movement of other ingredients already present inside the mixing chamber 110 as they move around the mixing path 124.

The mixer 100 also includes an outlet 150. The outlet 150 includes an outlet aperture 152 in the curved wall of the cylindrical mixing chamber 110. The outlet 150 also includes an outlet conduit 154 that extends from the outlet aperture 152. The outlet conduit 154 extends away from the mixing chamber 110 in a direction toward the direction of the mixing path 124. In particular, in the orientation shown in FIG. 1, the mixing path 124 has a generally downward direction at the point adjacent to the outlet 150, and the outlet conduit 154 extends from the mixing chamber 110 in a generally downward direction. Here, the first inlet 130 and the outlet 150 are spaced from one another such that the slurry exiting the outlet 150 is substantially homogenous.

The outlet conduit 154 of the outlet 150 extends away from the mixing chamber 110 such that a longitudinal axis 156 of the inlet conduit 154 is parallel to, and spaced from, a second tangent 142 to the circular mixing path 124. The second tangent 142 is a tangent to the mixing path 124 at a point adjacent to the outlet aperture 152. Accordingly, mixed slurry may be removed from the mixing chamber 110 via the outlet 150 in a direction that is tangential to the direction of movement of the mixed slurry as it moves around the mixing path 124 inside the mixing chamber 110.

FIG. 2 is a schematic cross-sectional side view of the stucco slurry mixer 100 shown in FIG. 1. As can be seen in FIG. 2, the mixing arm 120 is positioned between the first inlet 130 and the outlet 150. The mixer 100 also includes a second inlet 160 that is shown to be on the same side of the mixing arm 120 as the first inlet 130, such that the mixing arm 120 is also positioned between the second inlet 160 and the outlet 150.

The inlet aperture 132 is positioned in the curved wall 112 of the mixing chamber 110 near to an upper surface 114 of the mixing chamber 110. The inlet conduit 134 extends away from the cylindrical mixing chamber 110 such that the longitudinal axis 136 of the inlet conduit 134 is parallel to, spaced from, and above a plane 128 in which the mixing arm 120 lies.

The outlet aperture 152 is positioned in the curved wall 112 of the mixing chamber 110 near to a lower surface 116 of the mixing chamber 110. The outlet conduit 154 extends away from the cylindrical mixing chamber 110 such that the longitudinal axis 156 of the outlet conduit 154 is parallel to, spaced from, and below a plane 128 in which the mixing arm 120 lies.

To mix a slurry with the mixer 100 shown in FIGS. 1 and 2, ingredients such as stucco, water, and any desired additives may be introduced into the mixing chamber 110 via the second inlet 160. The mixing arm 120 may then be rotated to mix the ingredients into a stucco slurry. As the slurry is moved by the mixing arm 120, foam may be introduced via the first inlet 130. Due to the tangential arrangement of the first inlet 130, the shear stresses experienced by the foam on entry to the mixing chamber 110 may be minimised. The foam may be evenly dispersed throughout the slurry due to the motion of the slurry and the movement of the mixing arm 120. Once the slurry and foam have been mixed to a desired extent, the mixed slurry may be removed from the mixing chamber 110 via the outlet 150. Due to the tangential arrangement of the outlet 150, the shear stresses experienced by the foam on exit from the mixing chamber 110 may be minimised.

FIG. 3 is a schematic cross-sectional plan view of a second stucco slurry mixer 200. The mixer 200 includes a cylindrical mixing chamber 210. A mixing disk 220 is located within the mixing chamber 210 and is configured to rotate about a central point of rotation 222. The mixing disk 220 includes several teeth 226 along its outer edge. Although the teeth 226 are shown in FIG. 3 to be spaced, the teeth 226 may be adjacent. Accordingly, more teeth 226 than shown in FIG. 3 may be provided. The mixing disk 220 is shown to rotate clockwise in the orientation shown in FIG. 3, but anti-clockwise rotation of the mixing disk 220 is also envisaged. Rotation of the mixing disk 220 about the point of rotation 222 defines a circular mixing path 224. The mixing path 224 shown in FIG. 2 is defined by the movement of an end of a tooth 226 of the mixing disk 220.

The mixer 200 includes a first inlet 230. The mixer 200 also includes a second inlet, which will be described in more detail with reference to FIG. 4 below. The first inlet 230 includes an inlet aperture 232 in a curved wall of the cylindrical mixing chamber 210. The first inlet 230 also includes an inlet conduit 234 that extends from the inlet aperture 232. The inlet conduit 234 extends away from the mixing chamber 210 in a direction opposed to the direction of the mixing path 224. In particular, in the orientation shown in FIG. 3, the mixing path 224 has a generally upward direction at the point adjacent to the first inlet 230, and the inlet conduit 234 extends from the mixing chamber 210 in a generally downward direction.

The inlet conduit 234 of the first inlet 230 extends away from the mixing chamber 210 such that a longitudinal axis 236 of the inlet conduit 234 is parallel to, and spaced from, a first tangent 240 to the circular mixing path 224. The first tangent 240 is a tangent to the mixing path 224 at a point adjacent to the inlet aperture 232. Accordingly, ingredients, such as aqueous foam, may be introduced into the mixing chamber 210 via the first inlet 230 in a direction that is tangential to the direction of movement of other ingredients already present inside the mixing chamber 210 as they move around the mixing path 224.

The mixer 200 also includes an outlet that is not shown in FIG. 3 and will be described in more detail with reference to FIG. 4 below.

FIG. 4 is a schematic cross-sectional side view of the second stucco slurry mixer 200 shown in FIG. 3. The outlet 250 includes three outlet apertures positioned in a lower surface 216 of the mixing chamber 210, with respective outlet conduits extending therefrom. The outlet conduits extend away from the outlet apertures in a direction away from the lower surface 216 of the mixing chamber 210. In the orientation shown in FIG. 4, the outlet conduits extend downwards.

As can be seen in FIG. 4, the mixing disk 220 is positioned between the first inlet 230 and the outlet 250. The mixer 200 also includes a second inlet 260 that is shown to be on the same side of the mixing disk 220 as the first inlet 230, such that the mixing disk 220 is also positioned between the second inlet 260 and the outlet 250.

The inlet aperture 232 is positioned in the curved wall 212 of the mixing chamber 210 near to an upper surface 214 of the mixing chamber 210. The inlet conduit 234 extends away from the cylindrical mixing chamber 210 such that the longitudinal axis 236 of the inlet conduit 234 is parallel to, spaced from, and above a plane in which the mixing disk 220 lies.

To mix a slurry with the mixer 200 shown in FIGS. 3 and 4, ingredients such as stucco, water, and any desired additives may be introduced into the mixing chamber 210 via the second inlet 260. The mixing disk 220 may then be rotated to mix the ingredients into a stucco slurry. As the slurry is moved by the mixing disk 220, foam may be introduced via the first inlet 230. Due to the tangential arrangement of the first inlet 230, the shear stresses experienced by the foam on entry to the mixing chamber 210 may be minimised. The foam may be evenly dispersed throughout the slurry due to the motion of the slurry and the movement of the mixing disk 220. Once the slurry and foam have been mixed to a desired extent, the mixed slurry may be removed from the mixing chamber 210 via the outlet 250.

1. A stucco slurry mixing apparatus comprising:
a vessel for receiving and mixing ingredients therein;
a mixing member configured to move within the vessel and mix ingredients contained therein, wherein the movement of the mixing member defines a non-rectilinear mixing path;
wherein the vessel comprises:
a first inlet for the introduction of ingredients comprising at least aqueous foam into the vessel, wherein the first inlet comprises an inlet aperture in a wall of the vessel and an inlet conduit extending therefrom such that a relative angle between a longitudinal axis of the inlet conduit and a tangent to the mixing path is less than 90 degrees;
a second inlet comprising a second inlet aperture in a wall of the vessel for the introduction of further ingredients into the vessel; and
an outlet for mixed slurry,
wherein the first inlet and outlet are positioned such that, in use, the average residence time of the aqueous foam within the vessel is similar to the average residence time of the other components of the stucco slurry within the vessel.

2. The stucco slurry mixing apparatus of claim 1, wherein the inlet conduit extends from the inlet aperture in a direction away from a direction of rotation of the mixing member.

3. The stucco slurry mixing apparatus of claim 1, wherein the mixing path lies entirely within a single plane and the longitudinal axis of the inlet conduit lies parallel to and spaced from the plane in which the mixing path lies.

4. The stucco slurry mixing apparatus of claim 1, wherein the mixing member is positioned between the first inlet and the outlet.

5. The stucco slurry mixing apparatus of claim 1, wherein the mixing member is positioned between the second inlet and the outlet.

6. The stucco slurry mixing apparatus of claim 1, wherein the inlet aperture is in a side wall of the vessel.

7. The stucco slurry mixing apparatus of claim 1, wherein the second inlet aperture is in a top wall of the vessel.

8. The stucco slurry mixing apparatus of claim 1, wherein the second inlet is spaced from the first inlet.

9. The stucco slurry mixing apparatus of claim 1, wherein the inlet aperture is elliptical or oval in shape.

10. The stucco slurry mixing apparatus of claim 1, wherein the inlet conduit extends from the inlet aperture such that a relative angle between the longitudinal axis of the inlet conduit and the tangent to the mixing path is less than 45 degrees.

11. The stucco slurry mixing apparatus of claim 1, wherein the inlet conduit extends from the inlet aperture such that a relative angle between the longitudinal axis of the inlet conduit and the tangent to the mixing path is less than 20 degrees.

12. The stucco slurry mixing apparatus of claim 1, wherein the inlet conduit extends from the inlet aperture such that the longitudinal axis of the inlet conduit is parallel to the tangent to the mixing path.

13. The stucco slurry mixing apparatus of claim 1, wherein the vessel further comprises a third inlet.

14. The stucco slurry mixing apparatus of claim 1, wherein the outlet comprises an outlet aperture and an outlet conduit extending therefrom, wherein the outlet conduit diverges from a direction of rotation of the mixing member as it extends away from the outlet aperture.

15. The stucco slurry mixing apparatus of claim 14, wherein a relative angle between a longitudinal axis of the outlet conduit and a further tangent to the mixing path is less than 90 degrees.

16. The stucco slurry mixing apparatus of claim 1, wherein the mixing path is circular.

17. The stucco slurry mixing apparatus of claim 1, wherein, in use, the average residence time of the aqueous foam within the vessel is within 30% of the average residence time of the other components of the stucco slurry within the vessel.

18. The stucco slurry mixing apparatus of claim 1, wherein, in use, the average residence time of the aqueous foam within the vessel is within 20% of the average residence time of the other components of the stucco slurry within the vessel.

19. A method of mixing a stucco slurry using the stucco slurry mixing apparatus as claimed in claim 1, the method comprising the steps: introducing ingredients including at least aqueous foam into the vessel via the first inlet; introducing further ingredients into the vessel via the second inlet, moving the mixing member to mix the ingredients within the vessel and removing mixed slurry from the vessel via the outlet, wherein the average residence time of the aqueous foam within the vessel is similar to the average residence time of the other components of the stucco slurry within the vessel.

20. The method of claim 19, wherein aqueous foam is the only ingredient introduced into the stucco slurry via the first inlet.

21. (canceled)
